(19) United States
(12) Patent Application Publication
(10) Pub. No.: US 2010/0260127 A1
(43) Pub. Date: Oct. 14, 2010

(54) SYSTEM AND METHOD FOR ROBUST TRANSMISSION IN AN ORTHOGONAL FREQUENCY DIVISION MULTIPLEXED COMMUNICATION SYSTEM

(75) Inventor: Robert G. Mechaley, JR., Kirkland, WA (US)

Correspondence Address: DAVIS WRIGHT TREMAINE, LLP/Seattle, 1201 Third Avenue, Suite 2200, SEATTLE, WA, 98101-3045, US

(73) Assignee: Eagle River Holdings LLC, Kirkland, WA (US)

(21) Appl. No.: 12/755,215

(22) Filed: Apr. 6, 2010

Related U.S. Application Data
(60) Provisional application No. 61/168,171, filed on Apr. 9, 2009.

(51) Int. Cl. H04W 72/04

(52) U.S. Cl. 370/329

(57) ABSTRACT

A system for robust transmission in an orthogonal frequency division multiplexed (OFDM) communication network is disclosed. An individual wireless communication device is assigned a set of OFDM tones for transmission in an uplink timeslot. If the received signal is not satisfactory, the number of OFDM tones assigned to the individual wireless communication device may be doubled such that the OFDM signal is duplicated in the additional set of OFDM tones. This process can be extended to multiple additional sets of OFDM tones. The multiple sets of OFDM tones may be combined at the base station to enhance recovery of the original transmitted signal. The assigned OFDM tones need not be contiguous within a block of available tones. Because a large number of OFDM tones are available, the concept may be extended to a large number of duplicate sets of OFDM tones. In a Group Call operation, each wireless communication device in the call group may be assigned multiple sets of OFDM tones to provide for more robust transmission.

### BACKGROUND OF THE INVENTION

1. Field of the Invention

The present invention is directed generally to communication systems and, more particularly, to techniques for robust transmission in an orthogonal frequency division multiplexed communication system.

2. Description of the Related Art

Public wireless networks have wide and ubiquitous coverage. The relatively high frequency range limits the communication range of a wireless communication device that is part of a wireless communication system. A particular limitation of a wireless communication network is penetration into structures or operation at peripheral edges of cell coverage. A wireless communication device in a public wireless network, such as GSM, TDMA, and the like, transmits in a designated timeslot. If the signal is weak because the mobile unit is in an interior portion of a structure or at the peripheral edge of cell coverage, a base station may not reliably detect the signal.

While it may be possible to boost the transmit power of such a mobile unit, the increased transmission power greatly diminishes the operating life a battery powering the mobile unit. In another alternative, it is possible to repeat the transmission of each data frame multiple times. That is, each data frame may be transmitted two or three (or more) times in a row in the hope that a base station will be able to detect one or more of the transmitted data frames. However, repeat transmission of data frames multiple times diminishes the bandwidth, and may not be practical in all situations. In addition, multiple transmissions of each and every data frame also increases power consumption significantly.

Therefore, it can be appreciated that there is a significant need for system and method of wireless communication that improves reliability of mobile station operation indoors or at peripheral edges of cell coverage. The present invention provides this, and other advantages, as will be apparent from the following detailed description and accompanying figures.

### BRIEF DESCRIPTION OF THE SEVERAL VIEWS OF THE DRAWING(S)

FIG. 1 illustrates an exemplary communication architecture used to implement a communication network in accordance with the present teachings.

FIG. 2 illustrates frequency allocation in an orthogonal frequency division multiplexed system.

FIG. 3 is a functional block diagram of a wireless communication device constructed in accordance with the present teachings.

FIG. 4 is a flowchart illustrating the operation of the system of FIGS. 1 and 2.

FIG. 5 illustrates frequency allocation in an orthogonal frequency division multiplexed system to assign multiple OFDM tone sets to a mobile unit in an uplink timeslot.

FIG. 6 is a flowchart illustrating the operation of the system to allocate OFDM tones in FIG. 5.

### DETAILED DESCRIPTION OF THE INVENTION

One difficulty in providing two-way like services on a public wireless network, such as GSM, TDMA, and the like, is synchronization of all mobile units so that all mobile units receive a message simultaneously. It is important for this Group Call function to be synchronized so that all units can act on a command at the same time. For example, a SWAT team preparing to simultaneously enter the front and back entrances of a building would want both entry teams to receive the commands to enter at exactly the same time. This simultaneity has been an issue for networks that use data packet technologies. Variations in data packet timing across the network and over the airlink make simultaneous reception unpredictable. Some systems attempt to synchronize transmissions by establishing a phone call and conferencing all the mobile units together. This technique is limited by the amount of time it takes to establish the phone call so that while communication is simultaneous, the setup of the call means a lag between pushing the button to talk and the actual establishment of the communication path. Neither of these techniques accurately replicates the experience of push-to-talk on a private two-way network.

The iDEN system remedied the drawbacks of traditional public wireless networks by placing all receiving units for a Group Call in receive mode at the same time. The iDEN network uses a time division technique which divides all communications into slices of time called timeslots. By directing all of the mobile units in a Group Call into a single timeslot containing the communications, all units receive the same communications at the same instant.

Orthogonal frequency division multiplex (OFDM) communications systems utilize a large number of closely-spaced subcarriers to transmit data. The input data is divided into a number of parallel data streams, one for each subcarrier. Each subcarrier is then modulated using a conventional modulation scheme, such as phase shift keying (PSK), quadrature amplitude modulation (QAM), or the like. The subcarriers are orthogonal to each other to prevent intercarrier interference. Those skilled in the art will appreciate that OFDM technology has developed into a popular communication technique for wideband wireless communication.

During a call setup process, the particular tones or groups of tones (i.e., subcarrier channels) are assigned to a particular mobile unit. The assignment of tones to a particular mobile unit during a channel set up operation and the actual communication process between a mobile unit and base station is well known in the art and need not be described in greater detail herein. However, the techniques described herein enable mobile units utilizing OFDM technology to be synchronized such that communications in a push-to-talk system are received simultaneously by all group members.

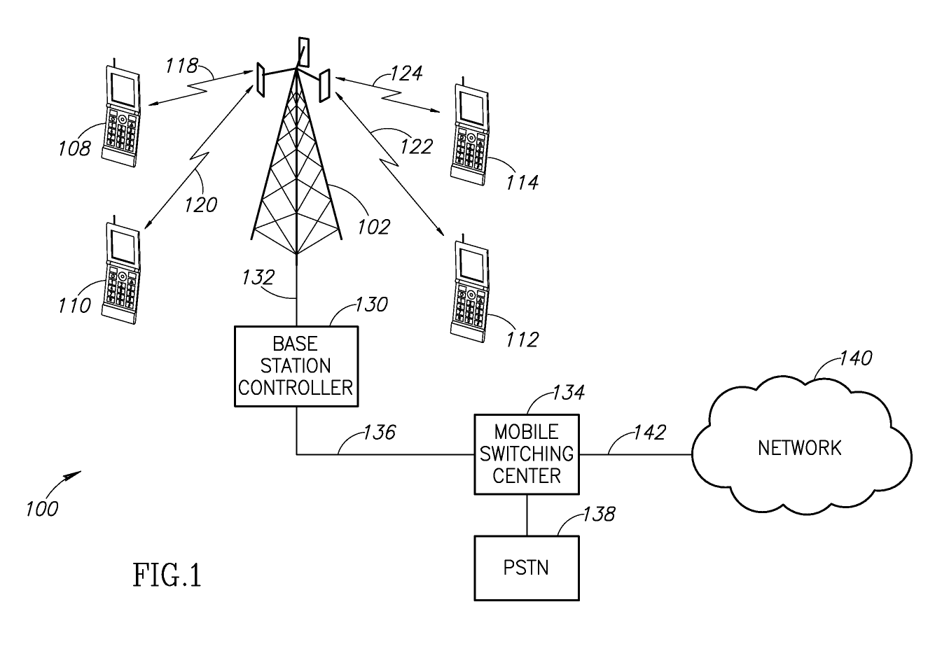

The communication techniques are implemented by a system 100 illustrated in FIG. 1. A base station 102 communicates with a plurality of wireless communication devices 108-114 via wireless communication links 118-124, respectively. The process of assigning tones or groups to each of the wireless devices (e.g., the wireless communication device 108) and the actual communication between the wireless communication devices 108-114 and the base station 102 are well-known in the art and need not be described in greater detail herein.

The base station 102 is communicatively coupled to a base station controller 130 via a communication link 132. In a typical embodiment, the base station controller 130 may provide operational control for one or more base stations 102. For the sake of clarity, only a single base station 102 is illustrated in FIG. 1.

In turn, the base station controller 130 is coupled to a mobile switching center (MSC) 134 via a communication link 136. As is known in the art, the MSC 134 is typically coupled to a large number of base station controllers and is responsible for switching and routing of calls to other base stations and/or a telephone network, such as the public switched telephone network (PSTN) 138.

The MSC 134 may also provide access to a core network 140 via a communication link 142. The core network 140 is the central part of a communication network that may include a number of functions, such as authorization, billing and the like. In addition, the network 140 may provide access to other networks, such as the Internet, for web applications via one or more gateways (not shown).

The MSC 134 is commonly used in circuit-switched networks. For packet-switched networks, a set of equivalent functions may be provided based on TCP/IP and VoIP technologies. The specific form of network elements may vary based on implementation details. However, those skilled in the art will understand that the OFDM implementation of the present teachings may be applicable to a variety of network architectures.

FIG. 1 is simplified to illustrate the operation of the system 100 with a group of wireless communication devices communicating in proximity with each other. In the illustrated embodiment, the wireless communication devices 108-114 are all communicating with the same base station (i.e., the base station 102). However, those skilled in the art will appreciate that the wireless communication devices 108-114 may communicate with other base stations as well. For the sake of simplicity, FIG. 1 also eliminates a number of conventional network elements, such as gateways, firewalls, and other control elements that are not pertinent to a clear understanding of the present teachings.

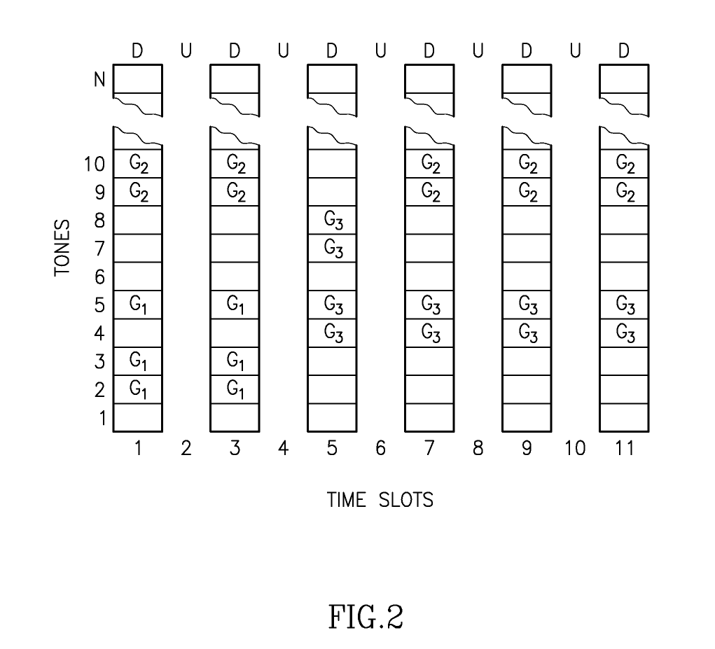

A group of mobile communication devices may be designated for operation in a Group Call function. When individual mobile communication units are designated as part of the same group, the wireless communication devices of that group will all be assigned the same OFDM tones for communication purposes. FIG. 2 illustrates a number of uplink and downlink timeslots and the designation of the tones to various groups. In the example illustrated in FIG. 2, a group of wireless communication devices (e.g., the wireless communication devices 108-110 are designated as Group1 As illustrated in FIG. 2, the wireless communication devices of Group1 are assigned tones 2, 3, and 5 in downlink timeslots 1 and 3. It should be noted that the assigned tones need not be contiguous. Furthermore, the number of tones assigned to a particular group can vary dynamically based on bandwidth requirements for the particular communication application. That is, simple audio communication may require less bandwidth than other forms of data communication, such as streaming video. Also illustrated in FIG. 2, is a second set of tones assigned to Group2 (e.g., the wireless communication devices 112-114). In this example, the wireless communication devices of Group2 are assigned tones 9 and 10. All wireless communication devices that are in a particular sector, cell, or area that identify it as a member of a certain group will receive a Group Call and are assigned the same set of OFDM tones within each timeslot on the downlink (those skilled in the art will appreciate that the downlink is conventionally considered the communication from the base station 102 to the wireless communication devices). Thus, in the example described herein, the wireless communication devices 108-110, which are assigned to Group 1 will all have the same OFDM tones assigned to each mobile unit.

The information for each group is encoded in a conventional fashion using the assigned tones. When the base station transmits the encoded information using the assigned tones for a group, all members in that Call Group will receive the information simultaneously. Thus, the techniques may be used to support a push-to-talk system in an OFDM communication network.

The concept illustrated herein is shown in FIG. 2 in a very simplified form with a relatively small number of tones assigned to individual ones of the groups (e.g., Group1, Group2, and Group3). However, a typical OFDM wave form contains hundreds or thousands of tones. This advantageously allows a large number of Group Calls to be supported simply by directing the appropriate wireless communication devices in each group to receive the appropriate tones or sets of tones assigned to that group. Again, FIG. 2 illustrates a simplistic version with only three groups set up with a relatively small number of tones assigned to each group. However, the principles described herein can be extended to a large number of groups.

FIG. 1 illustrates the wireless communication devices (e.g., the wireless communication devices 108-110) in a group (e.g., Group1) as communicating with a single base station. However, the principles of the present disclosure permit group members to be coupled to different base stations. In the example of the SWAT team described above, the actual team members may communicate with a single base station or with multiple base stations if the operational area for the SWAT team is a large geographical area. In addition, a command post, for example, may be established at some distance from the theater of operations. Thus, it is possible that the command post wireless communication device may be in communication with a different base station. While the frequency or carrier of the tones may differ from one base station to another, members of the designated group communicating with multiple base stations may still have the same sets of tones assigned thereto. Similarly, wireless communication devices in a single group may be communicating with the same base station, but with a different sector of that base station. In this fashion, all members of a designated group, whether coupled to the same sector or base station or coupled to different sectors or completely different base stations, can still be configured to simultaneously receive communications from other group members.

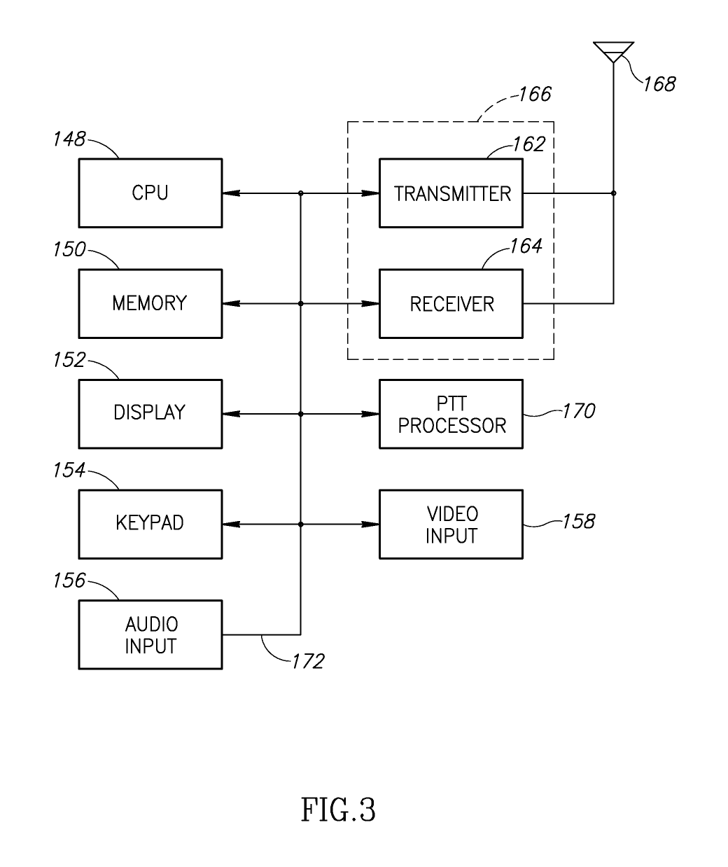

FIG. 3 is a functional block diagram of an electronic device, such as the wireless communication devices 108-114 in FIG. 1. The device includes a central processing unit (CPU) 148. Those skilled in the art will appreciate that the CPU 148 may be implemented as a conventional microprocessor, application specific integrated circuit (ASIC), digital signal processor (DSP), programmable gate array (PGA), or the like. The wireless communication device 108 is not limited by the specific form of the CPU 148.

The electronic device in FIG. 3 also contains a memory 150. The memory 150 may store instructions and data to control operation of the CPU 148. The memory 150 may include random access memory, ready-only memory, programmable memory, flash memory, and the like. The electronic device is not limited by any specific form of hardware used to implement the memory 150. The memory 150 may also be integrally formed in whole or in part with the CPU 148.

The electronic device of FIG. 3 also includes conventional components, such as a display 152, keypad or keyboard 154 and audio input device 156. The electronic device may also include a video input 158, such as a conventional built-in camera that is common in many wireless electronic devices. These are conventional components that operate in a known manner and need not be described in greater detail.

The electronic device of FIG. 3 also includes a transmitter 162 such as may be used by the wireless communication device 108 for normal wireless communication with the base station 102 (see FIG. 1). FIG. 3 also illustrates a receiver 164 that operates in conjunction with the transmitter 162 to communicate with the base station 102. In a typical embodiment, the transmitter 162 and receiver 164 are implemented as a transceiver 166. The transceiver 166 is connected to an antenna 168. Operation of the transceiver 166 and the antenna 168 is well-known in the art and need not be described in greater detail herein.

The wireless communication device in FIG. 23 also includes a push-to-talk (PTT) processor 170. The PTT processor 170 controls operation of the wireless communication device in a Group Call mode. The PTT processor 170 includes a PTT button (not shown) which, when activated by the user, places the device in a transmit mode such that outgoing communications from the PTT activated device will be transmitted, via the base station 102, to the wireless communication devices of the other group members.

Those skilled in the art will recognize that the PTT processor 170 may be implemented as a series of computer instructions stored in the memory 150 and executed by the CPU 148. However, the PTT processor 170 is shown as a separate block in the functional block diagram of FIG. 3 because it performs a separate function.

The various components illustrated in FIG. 3 are coupled together by a bus system 172. The bus system may include an address bus, data bus, power bus, control bus, and the like. For the sake of convenience, the various busses in FIG. 3 are illustrated as the bus system 172.

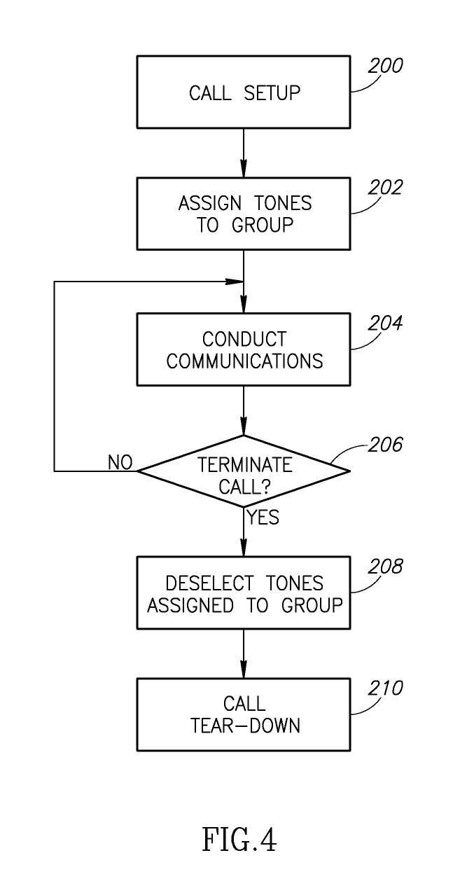

The operation of the system 100 is illustrated in the flow chart of FIG. 4. At step 200 the system 100 performs a call setup operation. In a typical group call arrangement, once a group call is set up, it is usually maintained for some predetermined or reserved time that is renewed each time a member of the group continues to communicate. If the predetermined or reserved period of time lapses with no group communication, the resources may be released and a call tear-down process initiated. Alternatively, it is possible to perform a call set-up and tear-down operation each time a push-to-talk button is activated by one of the group members. While the latter process may free OFDM tones for use in between communications by group members, there may be added overhead to set up and tear down the call each time a button is depressed. As those skilled in the art will appreciate, each time the call is set up, the OFDM tone or tones must be assigned to all group members. However, the present disclosure is intended to encompass either method. In step 202, the system 100 assigns tones to a designated group (e.g., Group1). In step 204, the group conducts communications in a conventional fashion. However, because each of the wireless communication devices in the designated group all have identical sets of OFDM tones assigned for the downlink, each group member will receive downlink communications simultaneously.

In step 206, the system determines if the call has been terminated. If the call is not terminated, the result of decision 206 is NO and the process returns to step 204 to continue conducting communications.

If the call is terminated, the result of decision 206 is YES and, in step 208, the system deselects tones assigned to the group. This makes the tones available for other network operations. In step 210, the system conducts a call teardown operation.

In another aspect, conventional wireless communication devices have less reliable communication links with a base station when the wireless communication device is within a structure or at a peripheral edge of the cell coverage area. The base station 102 may command the wireless communication device (e.g., the mobile unit 108 in FIG. 1) to increase its transmit power. This approach has a serious adverse on the battery and is thus an undesirable approach.

Another known approach to this problem is to transmit each data frame multiple times. That is, each data frame is transmitted two or more times in successive uplink timeslots. This approach reduces overall bandwidth for the mobile unit and may not be possible without dropping subsequent data frames. Furthermore, if the signal from the mobile unit is weak, retransmitting the weak signal for multiple data frames may not improve the overall reception by the base station 102.

In contrast with prior art approaches, the system 100 assigns OFDM tones or group of tones (i.e., subcarrier channels) to a particular wireless communication device for use during an uplink timeslot. That is, each wireless communication device wishing to communicate with the base station 102 is assigned different groups of tones to be used by the respective wireless communication devices while transmitting during the uplink timeslots. The number of tones assigned to a particular wireless communication device typically depends on the bandwidth requirements of that wireless communication device. That is, a wireless communication device having voice only communications requires less bandwidth, and is assigned fewer tones, than a wireless communication device that may be uploading image data. Those skilled in the art will appreciate that the number of OFDM tones may also be assigned to a particular wireless communication device on the basis of the level of service for a particular subscriber.

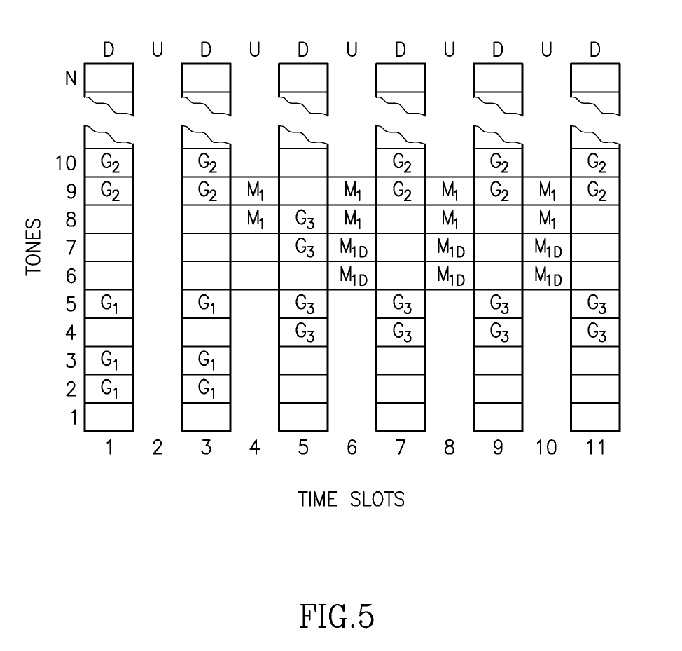

In accordance with the present teachings, a wireless communication device deep within a structure or at a peripheral edge of a cell coverage area can be assigned duplicate sets of OFDM tones. This concept is illustrated in FIG. 5. At an uplink timeslot 4, a wireless communication device (e.g., the wireless communication device 108 in FIG. 1) is assigned two groups of tones for uplink timeslot 4. In the subsequent uplink timeslots (i.e., timeslots 6-10) the base station 102 has doubled the number of OFDM tones allocated to the wireless communication device. In these timeslots, the data that is allocated for the two original groups of OFDM tones is simply duplicated into the additional groups of OFDM tones. While this approach does not require additional transmit power by the wireless communication device, the base station may combine the signals from the multiple groups of OFDM tones to more robustly recover the transmitted signal.

FIG. 5 illustrates the OFDM tone allocation for a particular wireless communication device (i.e., the wireless communication device 108 of FIG. 1) using adjacent OFDM tones in each uplink time slot. However, the system 100 does not require that the OFDM tones assigned to the wireless communication device 108 be contiguous. The base station 102 may assign the available OFDM tones without limitation. The only requirement is that the base station and wireless communication device must both know which OFDM tones or set of OFDM tones in the duplicate set or sets correspond to the original allocated OFDM tones.

This concept may be extended to additional groups of OFDM tones as well. Since a single OFDM timeslot can contain hundreds or thousands of tones, the principles illustrated in FIG. 5 can be extended far beyond a mere doubling of the OFDM tones allocated to single wireless communication device. Furthermore, in the Group Call communications examples provided above, each of the wireless communication devices within a group can be allocated multiple sets of OFDM tones to allow more robust recovery of the original transmitted signal from each of the wireless communication devices in the group. However, the principles illustrated in FIG. 5 are not limited only to Group Call situations.

The base station 102 (see FIG. 1) may determine when to assign multiple sets of OFDM tones to a particular wireless communication device. For example, the bit error rate (BER) or carrier to interference (C:I) ratio or other known measure could be used to determine when the signal received from the wireless communication device is inadequate. Under such circumstances the base station 102 can allocate an additional set of OFDM tones to that wireless communication device and instruct the wireless communication device to duplicate the transmitted signal.

In an exemplary embodiment, the base station 102 (see FIG. 1) may incrementally increase the number of sets of OFDM tones allocated to a single wireless communication device mobile station. For example, if doubling the number of allocated OFDM tones still provides a weak signal, the base station 102 may triple the allocation of OFDM tones to a particular wireless communication device. Alternatively, the base station 102 may determine how many times to duplicate the allocated OFDM tones based on a calculation, such as the BER or C:I, or the like.

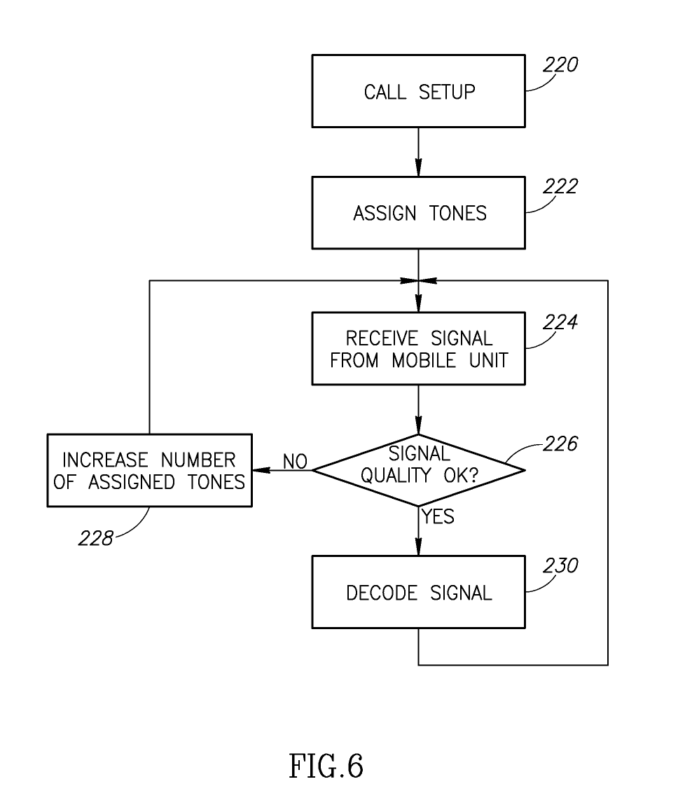

The operation of the system 100 in this aspect is illustrated in the flow chart of FIG. 6. At step 220, a call setup operation is initiated for a particular wireless communication device (e.g., the wireless communication device 108 in FIG. 1). In step 222, the system 100 assigns OFDM tones to the wireless communication device. This may be part of the call setup process, but is shown separately to illustrate the assignment of OFDM tones and duplicate OFDM tones (i.e., OFDM tones used to duplicate the symbols contained in the original OFDM tones). In step 224, the wireless communication device communicates with the base station 102 in a conventional fashion.

In decision 226, the base station 102 determines whether the signal quality is sufficient, i.e., the original transmitted data can be recovered. If the signal quality is not sufficient, the result of decision 226 is NO and, in step 228, the base station increases the number of OFDM tones assigned to the wireless communication device. The process returns to step 224 to receive additional signals from the wireless communication device that have been duplicated into the additional sets of OFDM tones. The process repeats until the signal quality is sufficient.

If the signal quality is sufficient, the result of decision 226 is YES and, in step 230 the base station 102 can satisfactorily decode the received transmissions from the wireless communication device (i.e., the wireless communication device 108 of FIG. 1) and recover the transmitted signal. The system 100 returns to step 224 to receive additional signals from the wireless communication device.

Those skilled in the art will appreciate that variations in the flow chart at FIG. 6 can occur while still within the scope of the present teachings. For example, the decode process in step 230 may, in fact, be part of the process by which the base station 102 determines whether the signal quality is sufficient. Furthermore, while not illustrated in FIG. 6, the base station may further determine that the signal strength from a particular wireless communication device exceeds requirements and de-allocate some of the additional duplicate sets of OFDM tones assigned to that wireless communication device.

Thus, the system 100 can use existing sets of OFDM tones to duplicate data in a particular uplink timeslot to thereby provide for a more robust recovery of the original transmitted signal. Existing wireless communication devices can be readily adapted to utilize duplicate sets of OFDM tones and thereby provide a more robust signal with a greater chance of recovery by the base station.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

The invention claimed is:

1. An orthogonal frequency-division multiplexed (OFDM) wireless communication system comprising:
a plurality of OFDM wireless communication devices;
a base station configured to communicate the plurality of OFDM wireless communication using a first set of assigned OFDM tones for a downlink and a second set of OFDM tones for an uplink; and
a base station controller configured to instruct a first of the plurality of OFDM wireless communication devices to transmit data to the base station using a third set of OFDM tones on the uplink in addition to the second set of OFDM tones,
wherein first of the plurality of OFDM wireless communication devices transmits data to the base station using more OFDM tones on the uplink than others of the plurality of OFDM wireless communication devices.

2. The system of claim 1 wherein the third set of OFDM tones are selected from a set of available OFDM tones and do not include any OFDM tones selected for the second set of OFDM tones.

3. The system of claim 1 wherein the second set of OFDM tones are selected from a set of available OFDM tones and are non-contiguous OFDM tones.

4. The system of claim 1 wherein the third set of OFDM tones are selected from a set of available OFDM tones and are non-contiguous OFDM tones and do not include any OFDM tones selected for the second set of OFDM tones.

5. The system of claim 1 wherein the base station controller is configured to instruct the first of the plurality of OFDM wireless communication devices to transmit data to the base station using the third set of OFDM tones on the uplink in addition to the second set of OFDM tones if a signal quality level is below a predetermined threshold.

6. The system of claim 1 wherein first base station controller is configured to instruct the first of the plurality of OFDM wireless communication devices to transmit data to the base station using the third set of OFDM tones on the uplink in addition to the second set of OFDM tones if a received error rate is above a predetermined threshold.

7. The system of claim 1 wherein the base station controller is configured to instruct the first of the plurality of OFDM wireless communication devices to transmit data to the base station using the third set of OFDM tones on the uplink in addition to the second set of OFDM tones if a carrier to interference ratio is below a predetermined threshold.

8. The system of claim 1 the base station controller is configured to increase the number of OFDM tones in the third set of OFDM tones for the first of the plurality of OFDM wireless communication devices.

9. The system of claim 8 wherein the base station controller is configured to increase the number of OFDM tones in the third set of OFDM tones for the first of the plurality of OFDM wireless communication devices if a signal quality level is below a predetermined threshold.

10. The system of claim 8 wherein the base station controller is configured to increase the number of OFDM tones in the third set of OFDM tones for the first of the plurality of OFDM wireless communication devices until a signal quality level is at a predetermined threshold.

11. A wireless communication device in an orthogonal frequency-division multiplexed (OFDM) wireless communication system having at least one base station and a plurality of wireless communication devices, comprising:
a receiver configured to receive data from the base station on a downlink using a first set of assigned OFDM tones;
a transmitter configured to transmit data to the base station on an uplink using a second set of assigned OFDM tones;
a controller configured to control operation of the transmitter and receiver, the controller being configured to control transmission wherein the controller instructs the transmitter to transmit data to the base station using a third set of OFDM tones on the uplink in addition to the second set of OFDM tones,
wherein the wireless communication device transmits data to the base station using more OFDM tones on the uplink than others of the plurality of OFDM wireless communication devices.

12. The system of claim 11 wherein the third set of OFDM tones are selected from a set of available OFDM tones and do not include any OFDM tones selected for the second set of OFDM tones.

13. The system of claim 11 wherein the second set of OFDM tones are selected from a set of available OFDM tones and are non-contiguous OFDM tones.

14. The system of claim 11 wherein the third set of OFDM tones are selected from a set of available OFDM tones and are non-contiguous OFDM tones and do not include any OFDM tones selected for the second set of OFDM tones.

15. The system of claim 11 wherein the controller is configured to instruct the transmitter to transmit data to the base station using the third set of OFDM tones on the uplink in addition to the second set of OFDM tones if a signal quality level at the base station is below a predetermined threshold.

16. The system of claim 11 the controller is configured to increase the number of OFDM tones in the third set of OFDM.

17. The system of claim 16 wherein the controller is configured to increase the number of OFDM tones in the third set of OFDM tones if a signal quality level is below a predetermined threshold.

18. The system of claim 11 wherein the controller is configured to increase the number of OFDM tones in the third set of OFDM tones until a signal quality level is at a predetermined threshold.

19. The system of claim 11 the controller is configured to decrease the number of OFDM tones in the third set of OFDM tones.

20. The system of claim 19 wherein the controller is configured to decrease the number of OFDM tones in the third set of OFDM tones if a signal quality level is above a predetermined threshold.

21. A method for wireless communication in an orthogonal frequency-division multiplexed (OFDM) wireless communication system having at least one base station and a plurality of wireless communication devices, comprising:
receiving data from the base station on a downlink using a first set of assigned OFDM tones;
transmitting data to the base station on an uplink using a second set of assigned OFDM tones;
determining a signal quality level on the uplink; and
transmitting data from a selected one of the plurality of wireless communication devices to the base station using a third set of OFDM tones on the uplink in addition to the second set of OFDM tones if the signal quality level on the uplink is unacceptable.

22. The method of claim 21 wherein the selected one of the plurality of wireless communication devices transmits data to the base station using more OFDM tones on the uplink than others of the plurality of OFDM wireless communication devices.

23. The method of claim 21 wherein the third set of OFDM tones are selected from a set of available OFDM tones and do not include any OFDM tones selected for the second set of OFDM tones.

24. The method of claim 21 wherein the second set of OFDM tones are selected from a set of available OFDM tones and are non-contiguous OFDM tones.

25. The method of claim 21 wherein the third set of OFDM tones are selected from a set of available OFDM tones and are non-contiguous OFDM tones and do not include any OFDM tones selected for the second set of OFDM tones.

26. The method of claim 21 wherein transmitting data from the selected one of the plurality of wireless communication devices to the base station uses the third set of OFDM tones on the uplink in addition to the second set of OFDM tones if a signal quality level at the base station is unacceptable.

27. The method of claim 26, further comprising receiving a message from the base station indicating that the signal quality level at the base station is unacceptable.

28. The method of claim 21, further comprising increasing the number of OFDM tones in the third set of OFDM tones.

29. The method of claim 28 wherein the number of OFDM tones in the third set of OFDM tones is increased if the signal quality level is unacceptable.

30. The method of claim 21 wherein the number of OFDM tones in the third set of OFDM tones is increased until the signal quality level is acceptable.

31. The method of claim 21, further comprising decreasing the number of OFDM tones in the third set of OFDM tones.

32. The method of claim 21, further comprising decreasing the number of OFDM tones in the third set of OFDM tones if the signal quality level is acceptable.

33. A method for communication in an orthogonal frequency-division multiplexed (OFDM) wireless communication system comprising:
a plurality of OFDM wireless communication devices communicating with a base station using a first set of assigned OFDM tones for a downlink
the plurality of OFDM wireless communication devices communicating with the base station using a second set of OFDM tones for an uplink; and
instructing a first of the plurality of OFDM wireless communication devices to transmit data to the base station using a third set of OFDM tones on the uplink in addition to the second set of OFDM tones,
wherein first of the plurality of OFDM wireless communication devices transmits data to the base station using more OFDM tones on the uplink than others of the plurality of OFDM wireless communication devices.

34. The method of claim 33 wherein the third set of OFDM tones are selected from a set of available OFDM tones and do not include any OFDM tones selected for the second set of OFDM tones.

35. The method of claim 33 wherein the second set of OFDM tones are selected from a set of available OFDM tones and are non-contiguous OFDM tones.

36. The method of claim 33 wherein the third set of OFDM tones are selected from a set of available OFDM tones and are non-contiguous OFDM tones and do not include any OFDM tones selected for the second set of OFDM tones.

37. The method of claim 33 wherein transmitting data from the selected one of the plurality of wireless communication devices to the base station uses the third set of OFDM tones on the uplink in addition to the second set of OFDM tones if a signal quality level at the base station is unacceptable.

38. The method of claim 37, further comprising determining the signal quality level at the base station.

39. The method of claim 33, further comprising increasing the number of OFDM tones in the third set of OFDM tones.

40. The method of claim 39 wherein the number of OFDM tones in the third set of OFDM tones is increased if the signal quality level is unacceptable.

41. The method of claim 33 wherein the number of OFDM tones in the third set of OFDM tones is increased until the signal quality level is acceptable.

42. The method of claim 33, further comprising decreasing the number of OFDM tones in the third set of OFDM tones.

43. The method of claim 33, further comprising decreasing the number of OFDM tones in the third set of OFDM tones if the signal quality level is acceptable.
